(19) United States
(12) Patent Application Publication
(10) Pub. No.: US 2008/0140539 A1
(43) Pub. Date: Jun. 12, 2008

(54) Medical Sales Representative Listing Service and System

(76) Inventor: Ernesto Cividanes, Coral Springs, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 11/951,763

(22) Filed: Dec. 6, 2007

Related U.S. Application Data
(60) Provisional application No. 60/868,848, filed on Dec. 6, 2006.

(51) Int. Cl. G06Q 30/00; G06Q 10/00

(52) U.S. Cl. 705/26

(57) ABSTRACT

The method and system provides sales leads and lead communications between medical sales reps (SR), medical pharmaceutical or equipment companies and medical providers (doctors, clinics). Each sales rep (SR) has a computer, email device or cell phone, linked to suppliers' computers and providers' computers. Data compilations of (i) SR profiles (with communications preferences and territorial parameters); (ii) medical supply company profiles (with sales contact portals); and (iii) pre-registered medical providers (with medical specialty data and territorial data) permit registered service providers to search SR data, and when territories match, generate a sales call request to the sales rep. When territories do not match, the company sales portal or hyperlink is provided. For non-registered providers, a general sales call or the company sales portal is displayed. Supply company administrators may approve-modify or upload SR profile data. Providers, after SR selection, select a pre-formatted text message and “time to visit” temporal data.

This is a regular patent application based upon and claiming the benefit of provisional patent application Ser. No. 60/868,848 filed Dec. 6, 2006.

### BACKGROUND OF THE INVENTION

The present invention relates to a computerized method and a system for generating sales leads and efficiently communicating those leads to medical sales representatives or reps (sales reps, herein “SR”) from professional medical service providers (such as doctors). These sales reps are usually associated with medical prescription or pharmaceutical companies and/or medical equipment supply companies. A large majority of these sales reps represent a single medical prescription company (pharmaceutical company or organization) or a single medical supply company. These sales reps engage in sales efforts and educational and promotional activities with the medical service providers in order to promote their pharmaceutical prescriptions and medical equipment to the professional service providers. Typical medical service providers include doctors, health clinics, hospitals and similar healthcare facilities and healthcare organizations. These professional medical service providers order medical prescriptions and supplies for others, that is, their patients, seeking medical assistance from the professional medical service providers.

With the ever increasing changes in the technology and increasing use of prescription or pharmaceutical preparations, the ongoing educational efforts by sales reps is important in order to (a) educate the professional medical providers and (b) provide proper, up-to-date material regarding prescriptions and medical supplies to the service providers which, in turn, provides a higher degree of healthcare services to the end users or consumers.

### OBJECTS OF THE INVENTION

It is an object of the present invention to provide a computerized system for sales lead generation and efficient lead communication linking medical sales reps with professional medical service providers and the medical prescription companies and medical supply companies.

It is another object of the present invention to provide a low cost or free information service to non-registered professional medical service providers such that those providers can locate medical prescription or pharmaceutical companies and medical companies.

It is a further object of the present invention to provide a sales lead generation and lead communication system enabling the medical service providers to quickly locate and communicate their desire to have a sales rep visit their operation.

It is a further object of the present invention to provide a communications link wherein the sales rep establishes a profile with a communications channel preference which, in some instances, includes email, text messaging (short message service, SMS) or interactive voice response (IVR) sending the sales call visit request to the sales rep's cell phone, telephone system or computer system.

It is a another object of the present invention to provide a quick and easy way toward the professional medical service provider to utilize one of several preformatted text messages to initiate the sales call request and to include, with the text message, a certain time frame as selected by the service provider.

It is an additional object of the present invention to track the sales lead generators in order to increase or adjust the compensation to the sales rep from his or her associated medical prescription or pharmaceutical company and/or medical supply company.

### SUMMARY OF THE INVENTION

In summary, the computerized method and system provides sales lead generation and enhanced lead communications linking medical sales reps, who are typically associated with medical prescription or pharmaceutical companies (and/or possibly medical equipment supply companies), and professional medical service providers (typically doctors) who order medical prescriptions and supplies for their patients. Each said sales rep has a computer or email enabled computing device and phone or text communications device. The medical suppliers' (pharmaceutical companies or equipment companies) use computers as do the medical service providers. These computers and the sales reps' computer or email enabled computing device and phone or text communications device are operatively coupled over a communications network (the Internet and other telecommunications systems). The method and the system uses a compilation or data collection of medical sales rep profiles which include, for each sales rep (SR), communications channel preferences, the associated medical supplier company data (who the SR represents) and at least one sales territorial parameter therefor. Administrators at the medical supplier company may approve-modify or upload this SR profile into the server-system of the invention. The method and system also uses a compilation or data collection of the medical prescription companies and medical supply companies which include, for each company (or business entity (the term “company” used interchangeably with any other business entity)), listings of medical prescription available therefrom and listings of medical supplies available therefrom. The company profile also includes a company sales contact communications portal, or data relative thereto or a data link of hyperlink. The system also includes a compilation or data collection of pre-registered professional medical service providers which include, for each respective medical provider, a respective medical specialty designator and a provider territorial parameter. These territorial parameters may be zip code designators or city-state designators or other geographic locators.

The system permits registered medical service providers to search the sales rep data collection and, when said sales territorial parameter proximally matches said provider territorial parameter, upon command of an inquiring medical service provider, the system generates a sales call request to the sales rep corresponding to the matching sales rep profile via the respective communications channel preference. In the absence of the proximal territorial match, the system provides the respective company sales contact communications portal or hyperlink to the inquiring medical service provider.

The system further permits non-registered medical service providers to search the sales rep data collection and, upon command of an inquiring non-registered medical service provider generating a general sales call to the respective company sales contact communications portal.

The system tracks these specific sales calls and generates bills usually to the medical prescription or pharmaceutical companies or medical equipment supply companies. The medical provider, after selection of a certain SR or sales rep can select a pre-formatted text message and insert or add temporal data for said sales call such as “call next week” or “call immediately.” Sales reps can search the pre-registered professional medical service provider data by medical specialty designator and, when the provider territorial parameter proximally matches the sales rep's territorial parameter, the system delivers the full contact profile of the pre-registered professional medical service provider. This enables the sales rep to pursue a cold call lead to the identified professional medical service provider.

It should be noted that the pharmaceutical company may populate or upload data to complete the SR profile and the professional medical service provider profiles. These later profiles may be purchased or may exist in other data collections in the in-house computer of the pharmaceutical company. The invention and the claims encompass this concept.

### BRIEF DESCRIPTION OF THE DRAWINGS

Further objects and advantages of the present invention can be found in the detailed description of the preferred embodiments when taken in conjunction with the accompanying drawings in which:

FIG. 1 is a Venn diagram wherein the product name for specific medical prescription or pharmaceutical products or medical equipment products intersect with a registered medical provider specialty and a registered provider zip code and the intersection of these three regions defines a sales rep (SR) territory. It is this territory that the computerized method and the information processing system seeks to exploit and enhance.

FIG. 2 is a flowchart or process diagram showing the registered professional program;

FIG. 3 is a flowchart or process diagram showing the sales rep (SR) program;

FIG. 4 is a process diagram or flowchart showing the unregistered user or provider program;

FIG. 5 is a flowchart or process diagram showing the sales rep input program;

FIG. 6 is a flowchart showing the sales rep profile update program;

FIG. 7 is the system administrator program; and

FIG. 8 diagrammatically illustrates the typical hardware system and telecommunications link for the present invention.

### DETAILED DESCRIPTION OF THE PREFERRED EMBODIMENTS

The present invention relates to a medical sales representative listing service and system which increases the communication between the professional medical service provider and the sales rep for particular prescription or pharmaceutical products and/or medical supply products in the geographic territory of both the service provider and the sales rep (SR).

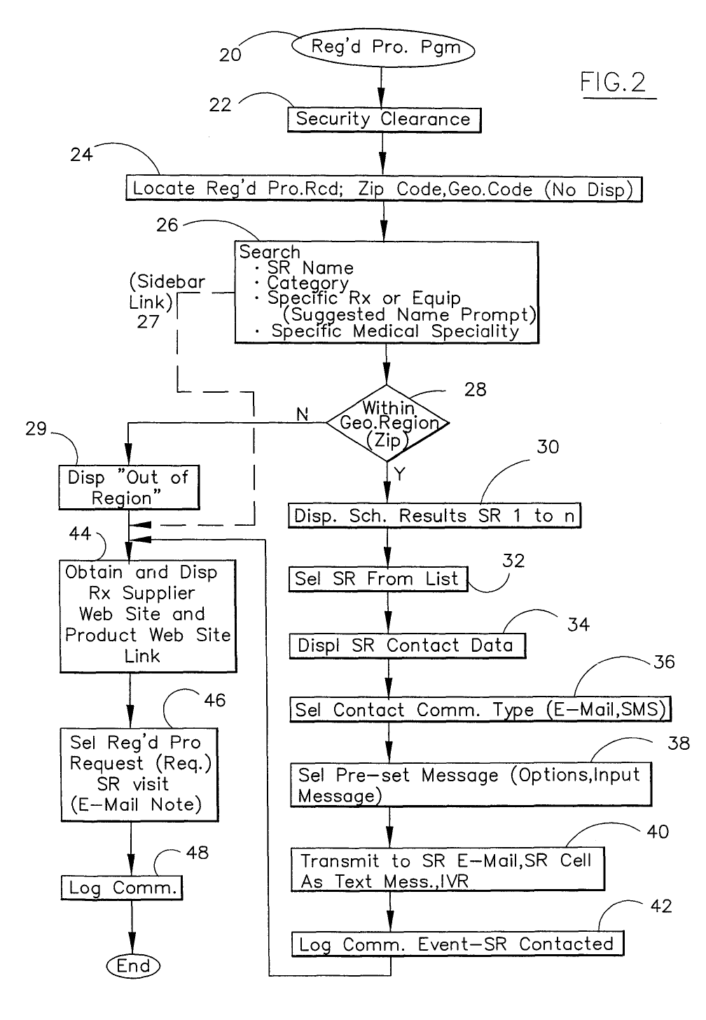

The diagrams FIGS. 2-8 describe one embodiment of the present invention, with variations therein. However, it should be noted that the particular sequence of steps in the flow charts may be reorganized to achieve higher efficiencies both in communication and computer access, input and output. Persons of ordinary skill in the art may reorganization of these steps to achieve higher efficiencies.

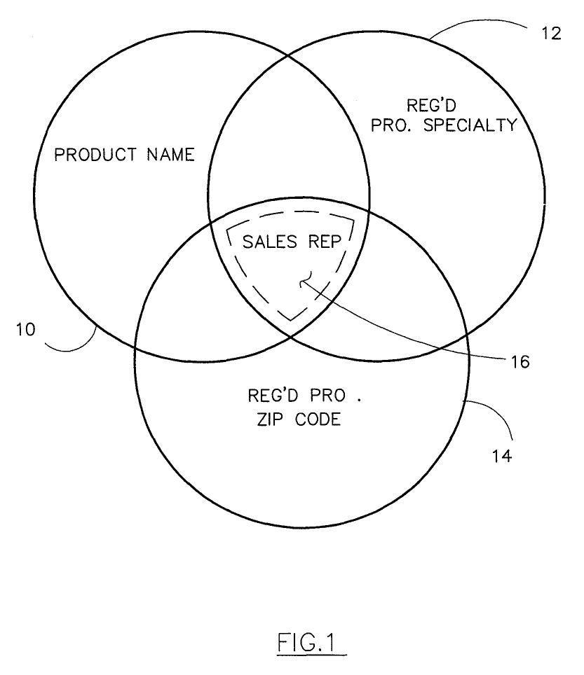

FIG. 1 shows a Venn diagram wherein the product name or product equipment falls within circle or region 10, the registered medical professional provider has a specific medical specialty within region 12 and the registered medical professional provider also has a zip code or territorial area encompassed by region 14. The intersection of regions 10, 12 and 14 is area 16 which represents the sales representative or rep (SR) area, both in a product sense and a geographic scope sense. In other words, the sales representative typically is assigned one or a small set of pharmaceutical products or medical equipment by a supplier. Further, the sale rep is also limited to a certain geographic territory or territorial parameter by the supplier. Sometimes these geographic areas are identified simply by one or more zip code areas. Other geographic mapping systems, such as city-state, may be used. Further, his or her target market is medical professionals having a specific medical specialty. Other medical specialties are typically not within the sales rep's contractually established or preferred target market. Therefore, there must be an intersection between the product offered for sale by the sales rep, the professional specialty which may need that pharmaceutical or medical equipment product as well as geographic territories of both the SR and the provider, typically overlapping or proximal zip codes.

The flowchart and system diagrams discussed herein sometimes use the abbreviations set forth below.

Abbreviations Table

| | |
|---|---|
| Admin | Administrator |
| ASP | application service provider - server on a network |
| comm. | communications, typically telecommunications |
| CPU | central processing unit |
| db | data base |
| Disp | display or code |
| doc | document |
| Equip | equipment |
| Geo | geographic location or code |
| HR | human resources or regional manager |
| I/O | input/output |
| mem | memory |
| Mess | message as in SMS or text message |
| pgm | program |
| Pro | provider, such as RX Pro, Medical Provider, namely, a doctor |
| P/W | password |
| Red | database record or record profile |
| re | regarding or relating to |
| Reg'd | registered as in Reg'd Pro, Registered Provider |
| rel | release |
| Req | request |
| rev | review |
| Rpt | Report |
| RX | medical drugs or medical equipment |
| sec | security |
| Sel | select |
| SR | sales representative |
| sys | system |
| t | time |
| tele-com | telecommunications system or network |
| URL | Uniform Resource Locator, x pointer, or other network locator |

FIG. 2 diagrammatically illustrates a flowchart or process diagram for one aspect of the present invention. The registered medical professional provider program 20 is shown in FIG. 2. In a preferred embodiment, the present invention utilizes a series of databases (spreadsheets in an alternative embodiment) (collectively, data collections or compilations). These databases can include a considerable amount of information about the sales representatives, the registered providers, and the medical suppliers. The system and method may be operable solely in-house, that is, by a single pharmaceutical company. Alternatively, the system may include a plurality of suppliers selling pharmaceuticals or prescriptions or medical equipment. As used herein, the term “sell” also includes the concept that the item can be leased. The databases may be populated with an upload of data from the supplier or other commercial information provider.

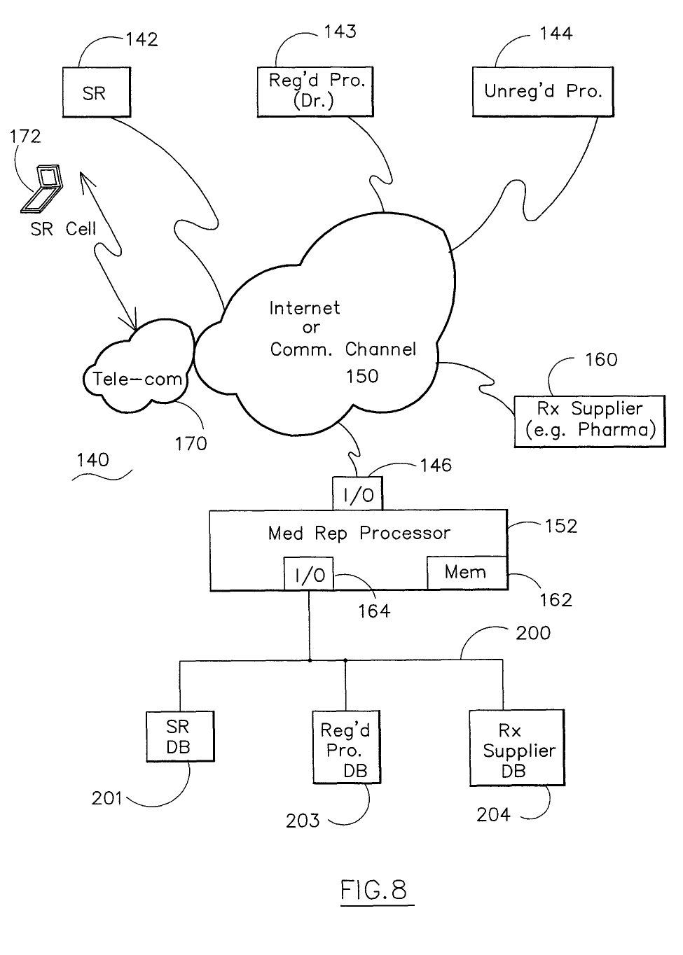

The Sales Representative Profile, Registered Provider Profile and RX Supplier Profile set forth below provide general outlines of the records in the sales rep or SR database, the Registered Provider database and the Medical Supplier database. See FIG. 8.

Sales Representative (SR) Profile
Common profile elements (name, address, phone, cell)
Associated company, position with company
medication category

specific RX product or products

medical equipment category

specific equip.

Territory or geographic scope (e.g. zip codes, city, state, geo locator)
Geo limit set by HR of associated company
Registered Provider (Reg'd Pro.) Profile
Common profile elements
Associated company
Category of medical specialty (maybe pull down menu)
Medical specialty
Y/N contact by email or otherwise
Contact person data
RX Supplier Profile
Common profile elements
HR admin data
Web site (and link thereto)
Medication category

specific RX medication with web link to product

Medical equipment category

specific equipment with web link

It is commonly known that in database or spreadsheet systems, users are customarily described as having profiles, typically a record or file which contains much information regarding the subject for the file. The SR database includes a plurality of sales rep profiles, one profile for each sales rep. This SR profile or record includes common profile elements such as name, address, phone number, cell phone number, voice mail data, biographic hyperlink, email address, etc. In addition, the SR profile includes SR's associated company that sells product per orders taken or initiated by the sales rep. Further, the SR position of the company may be relevant and may be included in the SR profile. Most importantly, the SR profile should identify the specific medical prescription or pharmaceutical (or, if the medical supply company is represented by the sales rep, the specific medial equipment). An additional element may include the general category of the medication or the general category of the medical equipment. For example, the medication carrier inquiry may be cardiovascular drugs and the specific medication may be a brand of statin. In addition, the SR profile includes a territorial parameter or territorial geographic scope of the sales rep. The territorial scope may be defined by zip codes, city and state or other geographic locator. Further, the sales rep profile may include a geographic limit set by the human resources or sales manager of the company associated with the sales rep.

The Registered Provider Profile, typically stored in the Provider database, includes common profile elements (name, address, phone etc.) as well as the name and address of the associated company of the medical provider. The category of medical specialty may be listed. More importantly, the specific medical specialty (medical specialty designator) of the medical provider is listed. A field is established which permits the registered provider to determine whether he or she can be contacted by email, text message, voice mail or voice line by the sales rep. Data for that communications link is also in the data collection. Further, the registered provider will provide contact person data such that the sales rep can setup a sales visit or meeting with the contact person in the provider.

The medical supplier profile also includes common profile elements as well as human resources HR administrator data (district sales manager, sales person administrative director, for example), and website to the company and a hot link or hyperlink to that website, the medication category and specific prescriptions or pharmaceutical medications with one or more website links to the product pages. The supplier also has a sales contact communications portal for direct solicitation for product sales. If the medical supplier is an equipment company, the specific equipment sold or leased by the company and possibly the general description or category of the equipment is found. Also, specific website links to the product pages are included in the collection and specific profiles.

FIG. 2 diagrammatically illustrates the flowchart or one type of process, program and method for the registered provider program 20. Step 22 is a security clearance feature wherein the registered provider must input a password (P/W) to have access to the site. Of course, this password information would be located in the profile and the system checks the p/w in the profile with the input security code. Step 24 locates the registered provider record or profile and identifies the zip code or geographic code therein. This information is not typically displayed to the user. Step 26 permits the registered provider (or his or her staff) to search for the sales rep by name, to search for a category of drugs or equipment, or search for a particular drug or particular equipment. Sometimes, the provider is referred to as the inquiring provider. This specific drug search could be enhanced by the system proposing drug names once the first 2-5 letters of the drug name are input. Another search could be by specific medical specialty. Of course, since the registered provider has a profile, his or her specific medical specialty is known to the system by the provider profile. Decision step 28 determines whether the registered provider conducting the search is within the geographic region (identical zip code, adjacent zip code of near match zip code, all referred to as a proximal territorial match). If YES, the system executes step 30 which is display the SR search results, if more than one SR rep matches the geographic territory and the specific medical specialty, the system displays sales rep SR 1 to sales rep SR n. Step 32 enables the registered provider to select one of the sales rep from the list. Step 34 displays to the registered provider the entire sales rep SR contact data. Step 36 enables the registered provider to select the contact communications type that he or she would like to communicate the sales call request to the sales rep. In other words, it is typical to have the sales rep identity several modes of communications such that his customers, the registered providers, can contact him or her. The registered providers in step 36 can select one of those communications channels. The SR will have a preferred communications channel preference. This may be email or text message to a cell phone. The communications channels and specifics of the channel and the communications device are located in the SR profile. Step 38 enables the registered provider to select a preset or pre-formatted message or, optionally, input a free form message. The following table shows various pre-set or pre-formatted messages.

Pre-set Messages

Office visit [insert data: Reg'd Pro.] Requested
same as above add: as soon as possible
same next week
same when available
open message input

As indicated in the Messages Table, if a text message or SMS message was to be sent to the sales rep, the preset message may be “Office visit to Dr. Brown requested.” Alternatively, if Dr. Brown, the registered provider wanted to see the sales rep next week, the preset message could be “Office visit to Dr. Brown requested next week.” Therefore, the sales call request may include, at the option of the service provider, a sub-selection of temporal or time data related to the prospective sales call. This may be added or inserted to obtain a combined text message. Further, in addition to text messaging, the system may generate preformatted email messages, and those email messages may be (i) sent directly the SR email configured unit or (b) converted through interactive voice response (IVR) to voice mail message directed to the cell phone and voice message center of the sales rep. In addition, the sales rep may change his or her profile such that he receives both email, text messaging and a voice mail message all from the same preset message selected and adopted by the medical provider in step 38. Step 40 transmits to the sales rep the email, or the message to the SR cell phone as a text message or otherwise. Step 42 logs and records the communication event and indicates that the sales rep was contacted. At this point, the registered provider may exist the program. Alternatively, the registered provider may execute steps 44, 46 and 48 as discussed below.

If the result of search 28 and the geographic testing or proximal match between the provider territorial parameter and the sales territorial parameter is not acceptable, the NO branch is taken and step 29 displays to the registered provider that the selected drug has no identified sales rep in the area. Therefore, the display “out of region” provides that information to the registered provider. After step 29, the system executes step 44. Alternatively if the provider after step 42 wishes to obtain additional information, the system, in step 44 obtains and displays the medical prescription supplier or medical equipment supplier or supplier website as well as the product website link. This hyperlink or data is a contact communications portal to the supplier. By displaying the product link to the specific product page, the registered provider can easily go to and obtain information from the source of the product and learn more about the product. Step 46 enables the registered provider to select a general sales call request from the medical supplier that a sales rep should visit the registered provider. This typically would involved an email note but a preformed voice message may also initiate the sales call. Step 48 logs, records or stores this communication in.

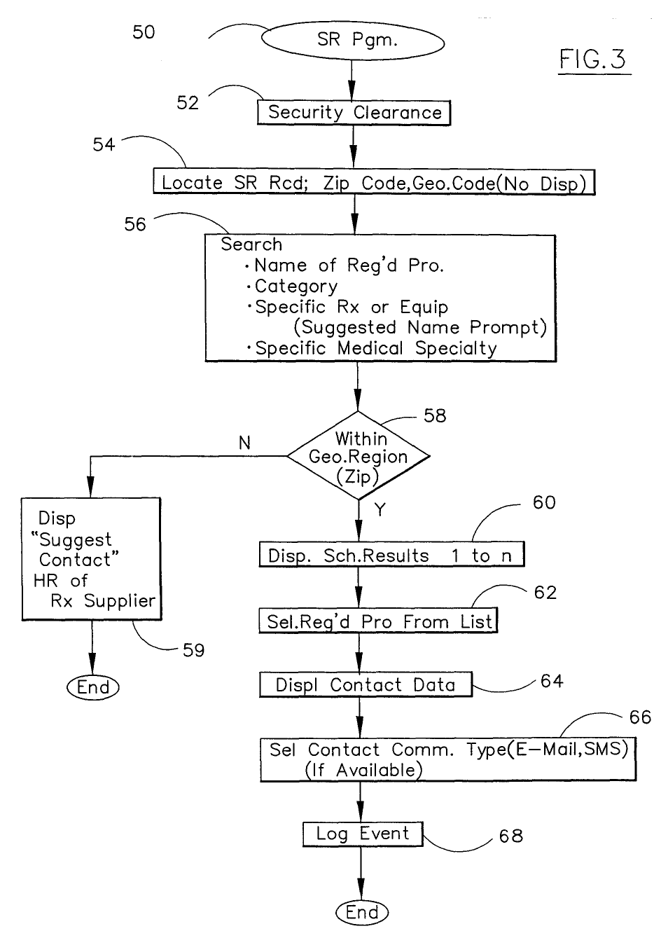

FIG. 3 is the sales rep or SR program 50. Step 52 is a security clearance p/w step wherein the sales rep or SR must input a password identical to the password stored in conjunction with the SR profile. Step 54 indicates that the system locates the SR record as well as the zip code or geographic code for the sales rep activating program 50. Step 56 enables the sales rep to search by name of registered provider, general medical category, specific medical specialty designator, specific drug or pharmaceutical, or specific medical equipment. Suggested name prompts may be displayed by the system as noted above in connection with search step 26. Further, and most important, the sales rep can search by specific medical specialty designator. Of course, since the SR profile has a specific pharmaceutical product data, that specific pharmaceutical can easily be linked to a specific medical specialty by the system without any input from the sales rep SR. Decision step 58 determines whether the inquiring sales rep conducting the search or activating the system has a corresponding registered medical provider within the geographic territory of the sales rep. If an exact match between a zip code is not possible, the system may be adjusted by the system operator or sys admin to search for adjacent zip codes or zip codes within a certain number of miles or targeted units from the specific zip code of the sales rep. If the output for decision step 58 is YES, the system, in step 60, displays the search results, that is, registered provider 1 through registered provider n. Step 62 enables the sales rep to select a particular registered provider from the list. Step 64 displays the contact data for that registered provider. Step 66 enables the sales rep to select a contact communication type which is found in the registered provider profile. In this manner, the sales rep can directly communicate with the contact person in the registered provider's office by email, text message, voice mail, voice or otherwise. In step 68, the system logs this communication event.

Returning to decision step 58, if the NO branch is taken indicating that there is no overlap between the sales territorial parameter of the sales rep and the medical provider territorial parameter, both obtained from various profiles in the data collections, the system, in step 58, displays to the sales rep “Suggest Contact HR, Human Resources” person or sales division manager at the medical supplier company. In other words, the sales rep has identified a registered provider outside of his or her territorial jurisdiction, the sales rep should be informed of that “out of territory” potential client and the system suggests that he or she contact the sales manager director at the company which he or she represents.

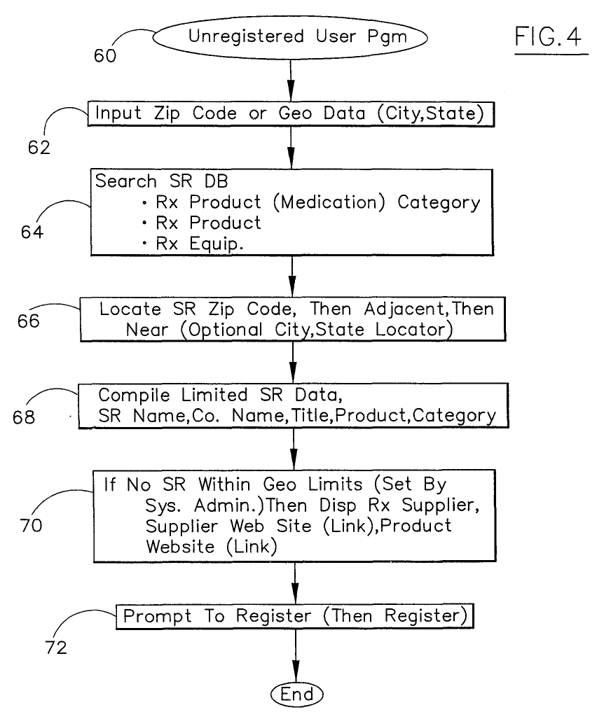

FIG. 4 diagrammatically illustrates the unregistered user or provider program 60. In step 62, the unregistered user/provider inputs his' or her's zip code or geographic data. In step 64, the unregistered inquiring user can search the sales rep database as well as the medical prescription product category database or medical prescription itself or medical equipment. Step 66 locates the sales rep zip code from the sales rep profile and then conducts an identical or adjacent search for proximally matching the zip code or geographic territorial identifier. Step 68 compiles limited sales rep contact data. This limited sales rep contact data includes the name of the sales representative, the company name, his or her title, the product carried by that sales rep and the category. Further contact information such as telephone number, cell phone number, email is NOT presented with limited contact data 68. In step 70, if no sales rep is found within the geographic limits set by the system administrator, then a display is provided to the unregistered user/provider listing the medical prescription supplier or medical equipment supplier, the supplier's website with a link and the product website with a link to the product page. This is the contact communications portal offered by the system. Step 72 prompts the unregistered user to register his or her data with the program to become a registered provider.

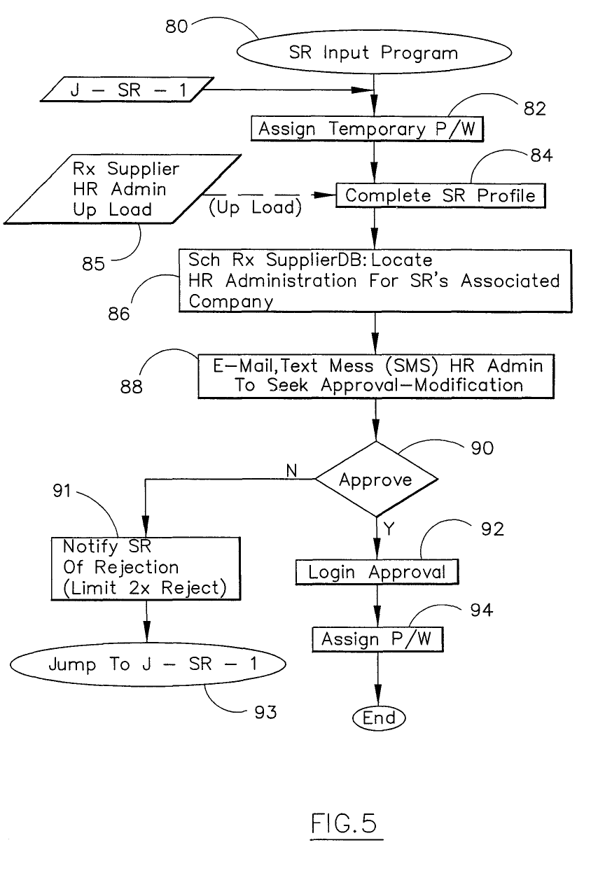

FIG. 5 is the sales rep or SR input program 80. In step 82, a temporary password P/W is assigned to the sales rep. In step 84, the sales rep completes his or her sales rep profile. Alternatively, the prescription supplier or medical equipment supplier in step 85 may have the human resources administrator (sales manager) upload the SR profile data to complete the SR profile in step 84. An in-house system may have all the SR profiles available. For an external system, in step 86, a search is conducted through the medical supplier database to locate the human resources administrator for the company associated with the sales rep. In step 88, a communications such as an email or text message or IVR or voice message is sent to the HR administrator to seek approval or modification of the SR profile input earlier in step 84. Step 90 decides whether the HR administrator approves of the SR profile data. If YES, the system logs in approval in step 92. In step 94, the password assigned to the sales rep SR is permanently assigned. Returning to decision step 90, if the HR administrator does not approve, the NO branch is taken and in step 91 the sales rep is notified of the rejection. If the sales rep has input profile data on two earlier occasions, a permanent block is put against the sales rep name for the system. In step 93, a jump JSR-1 is noted. This returns the prospective sales rep to a point preceding step 82.

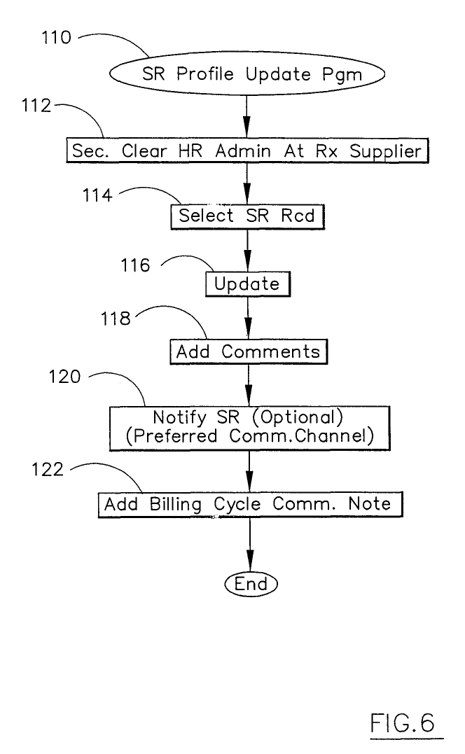

In FIG. 6, the sales rep profile update program 110 is summarized. In step 112, a security clearance for the HR administrator at the medical supply company is noted. Step 114 permits the HR administrator to select the sales rep or SR record. Step 116 enables the HR administrator to update the SR record. Step 118 permits the HR administrator or sales manager to add comments to the SR record. Step 120 notifies the sales rep of the comments. This notification may be optional. The notification would also use the preferred communications channel established by the sales rep and the SR profile. In step 122, the comment is added to the billing cycle communication as a communication note.

In all the compilation processes, additional approval and error correction steps may be added. For example with respect to the Provider database and specific provider profiles, each profile and the specific data therein may be cross-checked against public and private sources to insure that the data therein is accurate.

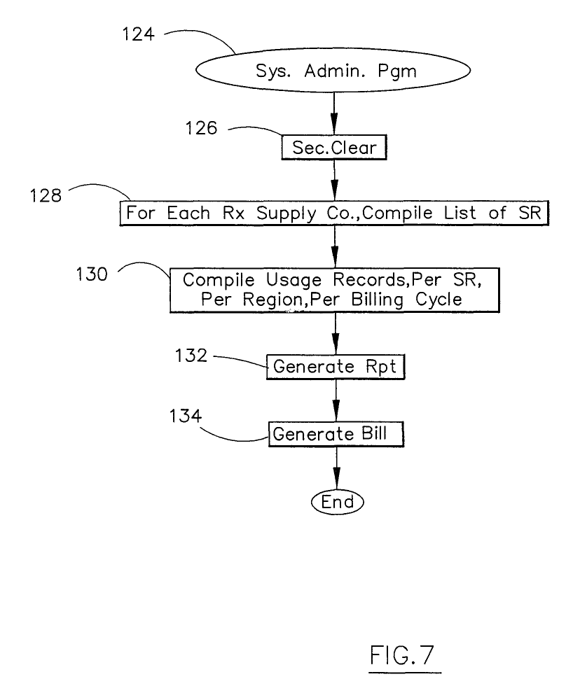

FIG. 7 diagrammatically illustrates the system administrator program 124. In step 126, a security clearance is established which limits a person's access to the system other than authorized system administrators. Step 128 enables the system administrator for each medical supply company to request a compilation of sales reps associated with that medical prescription company or medical equipment supply company. The system administrator of the exterior system must approve the upload request or download request from the supplier administrator. Otherwise, the system automatically generates the list for billing and reporting purposes. Step 130 complies usage records for all sales rep contacts handled by the system as well as usage records for each sales rep on a regional basis and also based upon a billing cycle. Typically, billing cycles are monthly.

Step 132 generates reports. These reports could be for each sales rep, could be for local sales managers (groups of SR reps) or could be for national sales managers at the medical supply company. Step 134 generates bills. The bills are generated for each sales call logged into the system. These invoices or bills are sent to the medical supplier associated with the sales rep.

FIG. 8 diagrammatically illustrates a computer system 140, a SR computer 142, and Reg's Pro. Computer 143 and unregistered user-provider computer 144 and a Rx supplier computer 160. These computers are operatively coupled together via a communications network. It should be noted that the system may be used in-house, by a single company—supplier, or may be exterior such that many suppliers use the system and the lead generation and communication method described herein. These computers 142, 143, 144, 160 and Med Rep Processor computer 152 are connected together via a communications network. Med Rep computer 152 is connected to one or more private databases or data structures which 201, 203, 204. In an in-house configuration, computers 160, 152 and databases 201, 203, 204 are all deployed in-house in one organization. The input/output device 146 is connected to a telecommunications system which leads to Internet 150. The Internet is a global computer network. Internet 150 is coupled to a Med Rep Processor server computer 152. Server 152 may be designated as an application service processor ASP. The ASP provides various tools to the user on computers 142, 143, 144 and 160 such as search through other data bases, indices and data structures, 201, 203, 204.

Typically, computers include a keyboard or data input device, a display, a central processing unit CPU, a fixed disc hard drive, a RAM, and input/output devices 147, 164, and memory 162. The system may include other removable disk drives, tape drives, or flash memory units. Internal units CPU, hard drive, RAM, input/output device, are all coupled together via an internal bus. Bus 200 is an internal bus to databases 201, 203, 204. The bus represents a plurality of buses as is known to persons of ordinary skill in the art.

One methodology of implementing the present invention utilizes a data base server. The present invention may also be embodied utilizing an Application Service Provider (ASP) on server 152 and in a client-server network with I/O 164, LAN or network 200, linked to databases 201, 203, 204. The user or operator on the PC 142 calls up an ASP on system 152 and operates the process on the computer system 152. Processing rules may be located with a uniform research locator or URL to find data collections or target files from computer stores 201, 203, 204. In a client-server environment, server 152 acts as a server generally cooperating with data operations with computers 142, 143, 144, 160. Of course, persons of ordinary skill in the art recognize that the server may be located on a local area network (LAN) rather than being interconnected with Internet 150 as shown in FIG. 8.

The preferred communications channels in the SR profile send data form Med Rep computer 152, sometimes through the Internet, sometimes through telephone carrier lines and to the SR cell phone 172 or the email enabled computer 142 or the personal data assistants (generally represented by cell phone 172 since data input/output is generally the same thereat). The Internet may or may not interact with telecommunications network 170. Processor 152 may directly communicate with tele-comm network 170.

The claims appended hereto are meant to cover the alternative embodiments.

The claims appended hereto are meant to cover modifications and changes within the scope and spirit of the present invention.

What is claimed is:

1. A computerized method for sales lead generation and lead communication linking medical sales rep or representatives, associated with respective medical prescription and supply companies, and professional medical service providers, ordering corresponding medical prescriptions and supplies for others, each said sales rep having a corresponding computer and phone or text communications device operatively coupled over a communications network with a plurality of medical service provider computers and corresponding computers of medical prescription companies and medical supply companies, comprising:
compiling a data collection of medical sales rep profiles which include, for each sales rep, communications channel preferences, one or more associated medical prescription companies and medical supply companies who are represented by the respective medical sales rep, and at least one sales territorial parameter therefor;
compiling a data collection of said one or more medical prescription companies and medical supply companies which include, for each respective medical prescription companies and medical supply companies, listings of medical prescription available therefrom and listings of medical supplies available therefrom, and a company sales contact communications portal;
compiling a data collection of pre-registered professional medical service providers which include, for each respective medical provider, a respective medical specialty designator and a provider territorial parameter;
permitting registered medical service providers to search the sales rep data collection and, when said sales territorial parameter proximally matches said provider territorial parameter, upon command of an inquiring medical service provider, generating a sales call request to the sales rep corresponding to the matching sales rep profile via the respective communications channel preference; and,
in the absence of the proximal territorial match, providing the respective company sales contact communications portal to said inquiring medical service provider; and,
permitting non-registered medical service providers to search the sales rep data collection and, upon command of an inquiring non-registered medical service provider generating a general sales call to the respective company sales contact communications portal.

2. A computerized method for sales lead generation and lead communication linking sales reps, professional medical service providers and medical prescription and supply companies as claimed in claim 1 including recording one or both of said sales call request and said general sales call over periodic billing cycles.

3. A computerized method for sales lead generation and lead communication linking sales reps, professional medical service providers and medical prescription and supply companies as claimed in claim 2 including generating bills for all sales call requests and general sales calls over said periodic billing cycle to respective medical prescription and supply companies receiving said sales call requests and general sales calls.

4. A computerized method for sales lead generation and lead communication linking sales reps, professional medical service providers and medical prescription and supply companies as claimed in claim 3 wherein some of said sales rep communications channel preferences include cell phone communications channel capable of text message services and some of said sales call requests are formatted text messages.

5. A computerized method for sales lead generation and lead communication linking sales reps, professional medical service providers and medical prescription and supply companies as claimed in claim 3 including providing a selection of pre-formatted text messages for selection by said inquiring medical service provider and providing sub-selections of temporal data for said sales call, said sub-selections forwarded with said text messages to said corresponding sales rep.

6. A computerized method for sales lead generation and lead communication linking sales reps, professional medical service providers and medical prescription and supply companies as claimed in claim 3 wherein said sales call request from said inquiring medical service provider is converted into a voice mail message designated to be delivered to said sales rep cell phone communications channel.

7. A computerized method for sales lead generation and lead communication linking sales reps, professional medical service providers and medical prescription and supply companies as claimed in claim 5 wherein said sales call request from said inquiring medical service provider is converted into a voice mail message designated to be delivered to said sales rep cell phone communications channel.

8. A computerized method for sales lead generation and lead communication linking sales reps, professional medical service providers and medical prescription and supply companies as claimed in claim 7 wherein each said respective medical prescription company and medical supply company includes a salesperson administrative director and the method includes confirming obtaining a confirmation of said sales territorial parameter for each sales rep prior to permitting registered medical service providers to search said sales rep data collection for a respective sales rep associated with the respective medical prescription company or medical supply company.

9. A computerized method for sales lead generation and lead communication linking sales reps, professional medical service providers and medical prescription and supply companies as claimed in claim 8 including permitting sales reps to search said pre-registered professional medical service providers data collection by respective medical specialty designator when said provider territorial parameter proximally matches said sales territorial parameter.

10. A computerized method for sales lead generation and lead communication linking sales reps, professional medical service providers and medical prescription and supply companies as claimed in claim 9 including permitting sales reps to search said non-registered professional medical service providers data collection by respective medical specialty designator when said provider territorial parameter proximally matches said sales territorial parameter.

11. A computerized method for sales lead generation and lead communication linking medical sales reps or representatives, each associated with a medical pharmaceutical company, and professional medical service providers, ordering corresponding medical pharmaceuticals for others, each said sales rep having a corresponding email enabled computer and phone or text communications device operatively coupled over a communications network with a plurality of medical service provider computers and corresponding computers of said medical pharmaceutical company, comprising:
compiling a data collection of medical sales rep profiles which include, for each sales rep, communications channel preferences, said associated medical pharmaceutical company represented by the respective medical sales rep, and at least one sales territorial parameter therefor;
permitting access to a data collection of said medical pharmaceutical company which includes listings of medical pharmaceutical products available therefrom and a company sales contact communications portal;
compiling a data collection of pre-registered professional medical service providers which include, for each respective medical provider, a respective medical specialty designator and a provider territorial parameter;
permitting registered medical service providers to search the sales rep data collection and, when said sales territorial parameter proximally matches said provider territorial parameter, upon command of an inquiring medical service provider, generating a sales call request to the sales rep corresponding to the matching sales rep profile via the respective communications channel preference; and,
in the absence of the proximal territorial match, providing the respective company sales contact communications portal to said inquiring medical service provider; and,
permitting non-registered medical service providers to search the sales rep data collection and, upon command of an inquiring non-registered medical service provider, providing the respective company sales contact communications portal to said inquiring non-registered medical service provider.

12. A computerized method for sales lead generation and communication as claimed in claim 11 including recording said sales call requests and generating bills therefor.

13. A computerized method for sales lead generation and communication as claimed in claim 12 wherein some of said sales rep communications channel preferences include one or more of cell phone communications channel, email communications channel, voice communications channel and voice messaging communications channel.

14. A computerized method for sales lead generation and communication as claimed in claim 13 including providing a selection of pre-formatted text messages for selection by said inquiring medical service provider and sub-selections of temporal data for said sales call, said sub-selections forwarded with said pre-formatted text messages to said corresponding sales rep.

15. A computerized method for sales lead generation and communication as claimed in claim 14 wherein said respective medical pharmaceutical company includes a sales director and the method includes logging a confirmation of said sales territorial parameter for each sales rep prior to permitting registered medical service providers to search said sales rep data collection.

16. A computerized method for sales lead generation and communication as claimed in claim 15 including permitting sales reps to search said pre-registered professional medical service providers data collection by respective medical specialty designator when said provider territorial parameter proximally matches said sales territorial parameter.

17. An information processing system for sales lead generation and lead communication linking medical sales reps or representatives, each associated with a medical pharmaceutical company, and professional medical service providers, ordering corresponding medical pharmaceuticals for others, the system deployed in a distributed computer system with a plurality of computers and a plurality of email enabled computers and phone or text communications device all operatively coupled to a communications network, a respective email enabled computer and phone or text communications device associated with each said sales rep, comprising:
a data collection of medical sales rep profiles which include, for each sales rep, data representative of communications channel preference, said associated medical pharmaceutical company represented by the respective medical sales rep, and at least one sales territorial parameter therefor;
a data collection of said medical pharmaceutical company which includes data representative of medical pharmaceutical products available therefrom and a company sales contact communications portal data;
a data collection of pre-registered professional medical service providers which include, for each respective medical provider, data representative of a respective medical specialty designator and a provider territorial parameter;
means for permitting registered medical service providers to search the sales rep data collection and, when said sales territorial parameter proximally matches said provider territorial parameter, upon command of an inquiring medical service provider, means for generating a sales call request to the sales rep corresponding to the matching sales rep profile via the respective communications channel preference; and,
means for displaying said respective company sales contact communications portal data and for providing a corresponding hyperlink to said inquiring medical service provider in the absence of the proximal territorial match; and,
means for permitting non-registered medical service providers to search the sales rep data collection and, upon command of an inquiring non-registered medical service provider, means for displaying the respective company sales contact communications portal data for providing a corresponding hyperlink to said inquiring non-registered medical service provider.

18. An information processing system for sales lead generation and communication as claimed in claim 17 including means for storing said sales call requests and a bill generator coupled thereto for periodic invoicing for said sales call requests.

19. An information processing system for sales lead generation and communication as claimed in claim 18 wherein some of said sales rep communications channel preferences include one or more of cell phone communications channel, email communications channel, voice communications channel and voice messaging communications channel.

20. An information processing system for sales lead generation and communication as claimed in claim 19 including providing means for selecting one of a number of pre-formatted text messages by said inquiring medical service provider and for selecting temporal data for said sales call, and means for combining said temporal data with said pre-formatted text messages; means for sending the combined pre-formatted text message and temporal data to said corresponding sales rep.

21. An information processing system for sales lead generation and communication as claimed in claim 20 wherein said respective medical pharmaceutical company includes a sales director and includes means for storing a confirmation of said sales territorial parameter for each sales rep prior to activation of said means for permitting registered medical service providers to search said sales rep data collection.

22. An information processing system for sales lead generation and communication as claimed in claim 21 including means for permitting sales reps to search said pre-registered professional medical service providers data collection by respective medical specialty designator when said provider territorial parameter proximally matches said sales territorial parameter.
